(19) United States
(12) Patent Application Publication
(10) Pub. No.: US 2008/0263256 A1
(43) Pub. Date: Oct. 23, 2008

(54) Logic Device with Write Protected Memory Management Unit Registers

(75) Inventors: Kevin S. Gudeth, Algonquin, IL (US); Eric Ridvan Uner, Carpentersville, IL (US)

Correspondence Address: LEVEQUE INTELLECTUAL PROPERTY LAW, P.C., 221 EAST CHURCH ST., FREDERICK, MD, 21701, US

(73) Assignee: MOTOROLA, INC., Schaumburg, IL (US)

(21) Appl. No.: 11/737,806

(22) Filed: Apr. 20, 2007

(51) Int. Cl. G06F 12/00

(52) U.S. Cl. 711/2

(57) ABSTRACT

A logic device. The logic device includes a control module, a memory management unit, a memory module, and at least one first register. The memory management unit controls flow of software code between the control module and the memory module; the control module programs at least one of the first registers during start-up procedures of the logic device to specify at least one data memory section in the memory module. The memory management unit communicates with the first registers to identify the at least one data memory section, and the memory management unit excludes executable code from storage in the at least one data memory section. After completion of the start-up procedures, the first registers are write protected, thereby preventing subsequent programming of the first registers, and the memory management unit cannot be disabled without shutting down the logic device.

### BACKGROUND

Modern network connected logic devices, such as computers and other devices, are vulnerable to intrusion or attack from clandestine sources which are referred to herein as attackers. Attackers find and use vulnerabilities in the software of embedded systems to execute their own code on the attacked system. Data interfaces of the system are used to deposit illicit code in a buffer somewhere in the system. Vulnerabilities in the system software are then used to transfer control of the code to inside the buffer. Buffer overflows or smashing the stack are often used to direct execution of some system code to some of the illicit code that has been surreptitiously placed in the system.

Many embedded logic device systems use the capabilities of memory management built into their microprocessors. This built-in memory management capability is often a memory management unit (MMU). Typically a memory management unit can be programmed to mark certain memory address ranges as having specified protection(s). After a memory address or a range of memory addresses is labeled by the memory management unit as having the specified protection(s), the memory management unit monitors those memory addresses for any invalid use of one or more of the identified addresses. If an invalid use of an address is detected, the memory management unit alerts the microprocessor, and the microprocessor then takes appropriate action.

One common protection provided by the memory management unit is the restriction of specified areas of memory to executable code and other specified areas of memory to non-executable code, i.e., data. If illicit code which an attacker intends to execute is delivered to a buffer from a clandestine source, that code will be written into the data range of memory and therefore will be non-executable. However, the attacker can then attempt to execute the code in the buffer. Since that buffer is marked as non-executable memory, the code from the attacker that was written into it will not execute but will cause the memory management unit to send an alert to the microprocessor.

The attacker will also know the memory management unit prevented the execution of the attacker's code. The attacker may then attempt to reprogram the memory management unit to change the protection assigned to the memory area of the buffer where the attacker's code resides to executable. Typically the memory management unit can be reprogrammed using those software routines which are used to program the memory management unit at startup. Once the attacker determines how to reprogram the memory management unit, the illicit code placed in that buffer can be executed.

### BRIEF DESCRIPTION OF THE DRAWINGS

The accompanying drawings provide visual representations which will be used to more fully describe various representative embodiments and can be used by those skilled in the art to better understand the representative embodiments disclosed and their inherent advantages. In these drawings, like reference numerals identify corresponding elements.

FIG. 1 is a drawing of a logic device having a memory management unit with protection configuration as described in various representative embodiments.

FIG. 2 is a drawing of another logic device having a memory management unit with protection configuration as described in various representative embodiments.

FIG. 3 is a flow chart of a method for protecting the configuration of the memory management unit of a logic device as described in various representative embodiments.

FIG. 4 is a flow chart of a method for notifying a logic device processor of a potential attack on a protected memory area of the memory module of FIGS. 1 and 2.

FIG. 5 is a drawing of still another logic device having a memory management unit with protection configuration as described in various representative embodiments.

FIG. 6 is a flow chart of another method for protecting the configuration of the memory management unit of a logic device as described in various representative embodiments.

FIG. 7 is a flow chart of a method for notifying a logic device processor of a potential attack on a protected memory area of the memory module of FIG. 5.

FIG. 8 is a drawing of yet another logic device having a memory management unit with protection configuration as described in various representative embodiments.

FIG. 9 is a flow chart of yet another method for protecting the configuration of the memory management unit of a logic device as described in various representative embodiments.

FIG. 10 is a flow chart of yet still another method for notifying a logic device processor of an attack on a protected memory area of the memory module of FIG. 8.

FIG. 11 is a flow chart of a method for notifying a logic device processor of a potential attack on a protected memory area of the memory module as described in various representative embodiments.

FIG. 12 is a drawing of still yet another logic device having a memory management unit with protection configuration as described in various representative embodiments.

FIG. 13 is a flow chart of another method for notifying a logic device processor of a potential attack on a locked memory area of the memory modules as described in various representative embodiments.

FIG. 14 is a flow chart of another method for notifying a processor of a potential attack on a locked memory area of the memory modules as described in various representative embodiments.

### DETAILED DESCRIPTION

As shown in the drawings for purposes of illustration, novel techniques are disclosed herein for preventing an attacker from executing code previously represented to a logic device, such as a computer, as data and subsequently stored in the system's memory by the attacker. Previous techniques have relied upon specifying memory address ranges in the system's memory as being either data or as being executable. The system is then expected to prevent an outside source from storing executable code in the data area and to prevent execution of that code since it is by definition data. However, a knowledgeable attacker can defeat such techniques by redefining areas of data memory as being executable. Techniques disclosed herein prevent the reprogramming of the system's memory management unit (MMU) so that it cannot be used by clandestine sources to change previously specified memory address ranges from being data memory to being executable memory. An attacker can thereby be prevented from executing code that had been previously represented to the system as data and stored in the data area of the system's memory but which was, in fact, executable code.

In the following detailed description and in the several figures of the drawings, like elements are identified with like reference numerals.

The term “translated address” is used herein to mean a memory address value that has experienced a mapping translation process that results in a secondary address, as well as a memory address that points directly to physical memory. The value of the translated address may represent a physical memory address, or it be used as an input for a translation process. Also, “translated memory” is memory that is accessed by translated addresses. The memory space of translated memory may or may not represent physical memory.

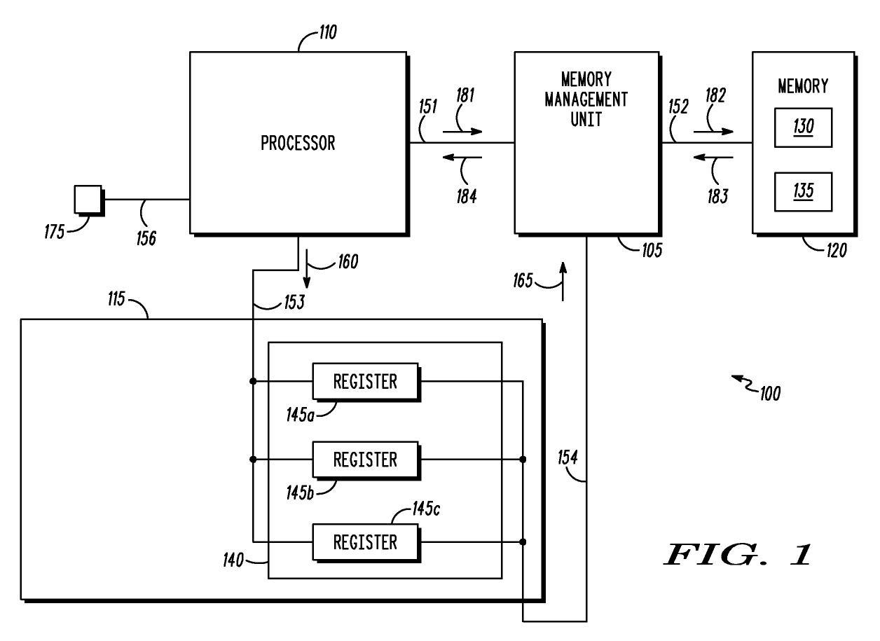

FIG. 1 is a drawing of a logic device 100 having a memory management unit 105 with protection configuration as described in various representative embodiments. The logic device 100 comprises a processor 110, which may be referred to more generally as a control module 110 herein, the memory management unit 105, a memory-management-unit register module 115, and a memory module 120. The memory-management-unit register module 115 may be referred to herein as register module 115. The memory module 120 comprises a data memory section 130 and an executable memory section 135. The logic device 100 further comprises an enabled indicator 175, which may also be referred to herein as first indicator 175. The register module 115 comprises a first register unit 140. The first register unit 140 comprises at least one first register 145 which may be implemented in hardware and/or software. Multiple first registers 145a,145b,145c are shown as first registers 145 in FIG. 1. In the representative embodiment of FIG. 1, the first registers 145 are write-once registers.

The processor 110 communicates with the memory management unit 105 via a first communication bus 151; the memory management unit 105 communicates with the memory module 120 and thereby with both the data memory section 130 and the executable memory section 135 via a second communication bus 152; the processor 110 also communicates with the first register unit 140 in the register module 115 and thereby with the first registers 145 in the first register unit 140 via a third communication bus 153; and the memory management unit 105 communicates with the first register unit 140 in the register module 115 and thereby with the first registers 145 in the first register unit 140 via a fourth communication bus 154. The processor 110 further communicates with the enable indicator 175 via a sixth communication bus 156.

The memory management unit 105 is used for managing memory accesses by the processor 110. The memory management unit 105 typically has the following capabilities: (1) translation of virtual addresses to translated addresses, (2) protection of the memory module 120, and (3) control of cache memory. In this representative embodiment, the memory management unit 105 is typically controlled by one or more first registers 145 implemented in hardware to perform these functions. These first registers 145 are programmed by the processor 110 via first register configuration data 160 transmitted to the first registers 145 on the third communication bus 153. First control data 165 is subsequently obtained from the programmed contents of the first registers 145 on the fourth communication bus 154. The first register configuration data 160 comprises attribute information specifying various sections of the memory module 120 as being data memory sections 130 which are permitted to contain only non-executable software code and various other sections of the memory module 120 as being executable memory section 135 which is permitted to contain executable software code.

Following the initiation of start-up, the registers 145 of the memory management unit 105 can be programmed only once. During initialization, the registers 145 will be programmed with integrity checked values used for normal run time. Once programmed, any attempt to reprogram any of the registers 145 will send an alert to the processor 110. The enabled indicator 175 which is used to enable the memory management unit 105 should also to be writable only once in order to prevent an attacker from disabling the memory management unit 105 thereby disabling the write protection of the registers 145.

During operation, the processor 110 transmits first communication signal 181 to the memory management unit 105 via first communication bus 151; the memory management unit 105 transmits second communication signal 182 to the memory module 120 via second communication bus 152; third communication signal 183 is received from the memory module 120 by the memory management unit 105 via second communication bus 152; and fourth communication signal 184 is received from the memory management unit 105 via first communication bus 151.

The first communication signal 181 may comprise data to be written into the data memory section 130 of the memory module 120, executable code to be written into the executable memory section 135 of the memory module 120, and/or instructions to the memory management unit 105; the second communication signal 182 may comprise data which was received from the processor 110 that is to be written into the data memory section 130 of the memory module 120 or executable code to be written into the executable memory section 135 of the memory module 120; the third communication signal 183 may comprise data which was read from the data memory section 130 of the memory module 120 or executable code which was read from the executable memory section 135 of the memory module 120; and the fourth communication signal 184 may comprise data which was read from the data memory section 130 of the memory module 120, executable code which was read from the executable memory section 135 of the memory module 120, or responses to instructions received by the memory management unit 105 from the processor 110. Once programmed, any attempt to reprogram any of the registers 145 will result in the memory management unit 105 sending an alert to the processor 110 as fourth communication signal 184 via first communication bus 151.

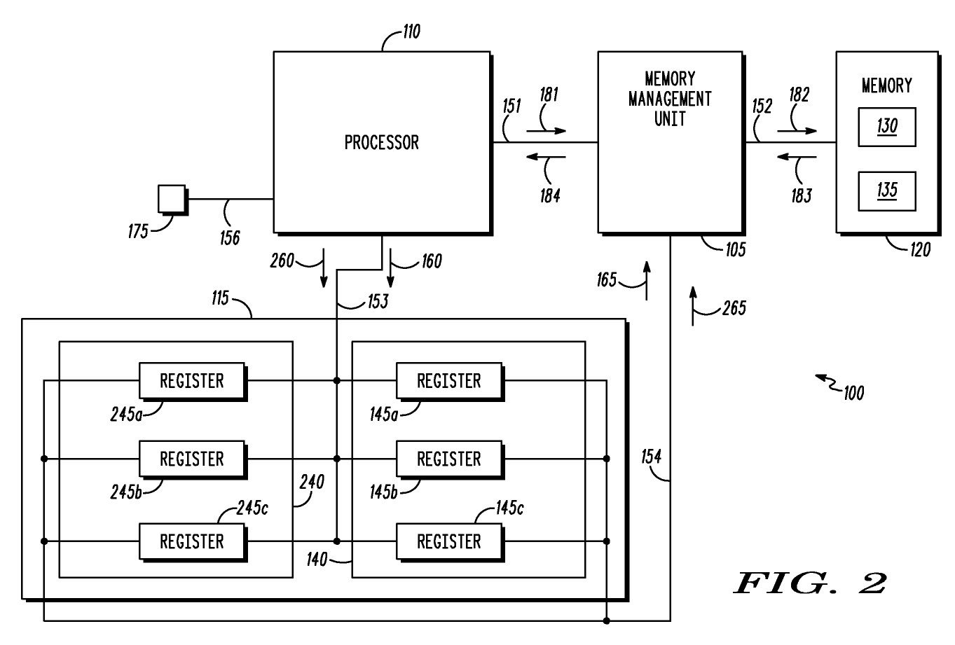

FIG. 2 is a drawing of another logic device 100 having a memory management unit 105 with protection configuration as described in various representative embodiments. In addition to the elements of the representative embodiment of FIG. 1 as described above, in the representative embodiment of FIG. 2 the register module 115 further comprises a second register unit 240. The second register unit 240 comprises at least one second register 245 which may be implemented in hardware and/or software. Multiple second registers 245a,245b,245c are shown as second registers 245 in FIG. 2. In the representative embodiment of FIG. 2, the second registers 245 of the second register unit 240 can be programmed without limit following the initiation of start-up.

The second registers 245 are programmed by the processor 110 via second register configuration data 260 transmitted to the second registers 245 on the third communication bus 153. Second control data 265 is subsequently obtained from the programmed contents of the second registers 245 on the fourth communication bus 254. Thus, the register module 115 comprises two sets of register units 140,240. As described above, the first registers 145 in the first register unit 140 can only be programmed once following the initiation of start-up. Whereas, the second registers 245 of the second register unit 240 can be programmed without limit following the initiation of start-up. Since memory boundaries are configured in the registers 145,245, it is possible that parts of the translated memory might be configured by more than one register 145,245. However, if the same area of translated memory is programmed into more than one register 145,245 wherein one of the registers 145 can only be written into only once following the initiation of start-up, i.e., it is one of the first registers 145 in the first register unit 240, an alert will be sent to the processor 110. Thus, an attacker cannot by-pass the write-once registers 145, i.e., the first registers 145, by reprogramming the multiple-write registers 245, i.e., the second registers 245, associated with the memory management unit 105. As in the representative embodiment of FIG. 1, the enabled indicator 175 needs to be protected from being reprogrammed by making them writable only once.

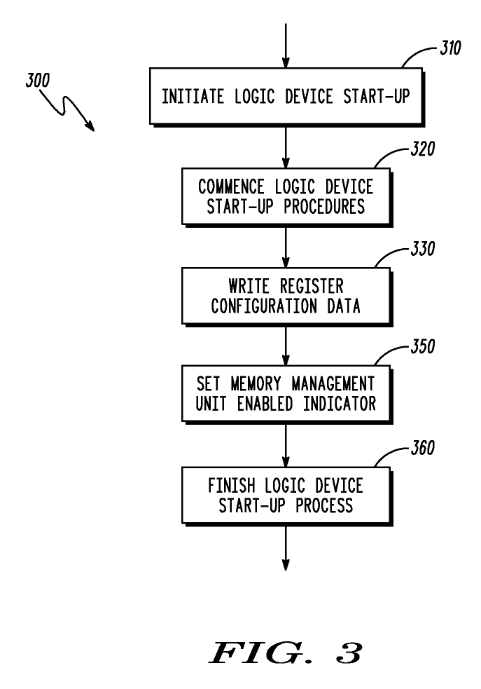

FIG. 3 is a flow chart of a method 300 for protecting the configuration of the memory management unit 105 of a logic device 100 as described in various representative embodiments. In block 310, start-up of the logic device 100 is initiated. Block 310 then transfers control to block 320.

In block 320, the logic device 100 start-up procedures are automatically commenced following the initiation of start-up. The use of the plural term “start-up procedures” is meant herein to include one or more procedures. Block 320 then transfers control to block 330.

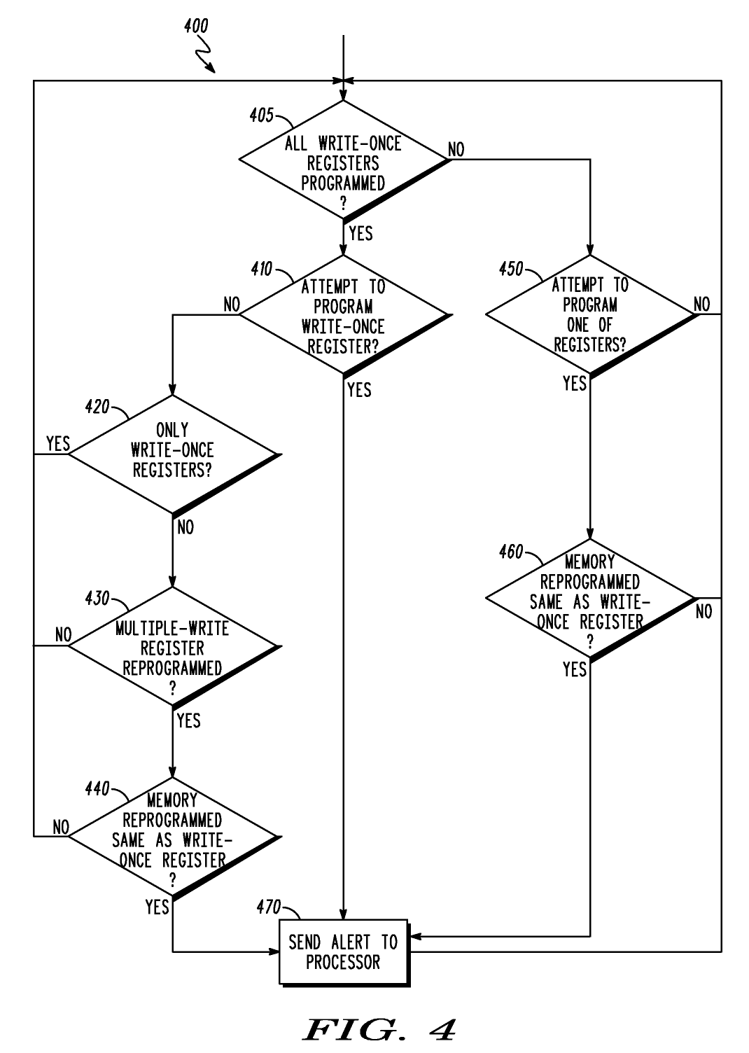

In block 330, first register configuration data 160 is written into the write-once registers 145. Should the register module 115 also comprise multiple-write registers 245, second register configuration data 260 is also written into the multiple-write registers 245 as appropriate. Note that it is possible that some write-once registers 145 may not be written into during the start-up process. This situation is considered as a part of FIG. 4. Block 330 then transfers control to block 350.

In block 350, the enabled indicator 175, which should be a write-once indicator, is set to indicate that the memory management unit 105 is now active. The enabled indicator 175 should be a write-once indicator so that an attacker is prevented from disabling the memory management unit 105 thereby disabling the write protection of the write-once registers 145. Block 350 then transfers control to block 360.

In block 360, the logic device 100 start-up procedures are completed. The start-up process is finished in block 360. The first registers 145 are now write protected.

FIG. 4 is a flow chart of a method 400 for notifying a logic device processor 110 of a potential attack on a protected memory area of the memory module 120 of FIGS. 1 and 2. If all of the write-once registers 145 have been programmed, block 405 transfers control to block 410.

If an attempt was made to reprogram one or more of the write-once registers 145, block 410 transfers control to block 470. Otherwise, block 410 transfers control to block 420.

If the memory-management-unit register module 115 comprises only write-once registers 145, block 420 transfers control back to block 405. Otherwise, block 420 transfers control to block 430.

If one or more of the multiple-write registers 245 were reprogrammed, block 430 transfers control to block 440. Otherwise, block 430 transfers control back to block 405.

If the area of translated memory of the attempt to program into one or more of the multiple-write registers 245 is the same as the translated memory programmed in one of the write-once registers 145, block 440 transfers control to block 470. Otherwise block 440 transfers control back to block 405.

If an attempt was made to reprogram one or more of the write-once registers 145 or one or more of the multiple-write registers 245, block 450 transfers control to block 460. Otherwise, block 450 transfers control back to block 405.

If the area of translated memory of the attempt to program into one or more of the write-once registers 145 or one or more of the multiple-write registers 245 is the same as the translated memory already programmed in one of the write-once registers 145, block 460 transfers control to block 470. Otherwise block 460 transfers control back to block 405.

In block 470, the processor 110 is notified of an attack on the locked (protected) memory area of the memory module 120 via the configuration data in the registers 145,245. Block 470 then transfers control back to block 405.

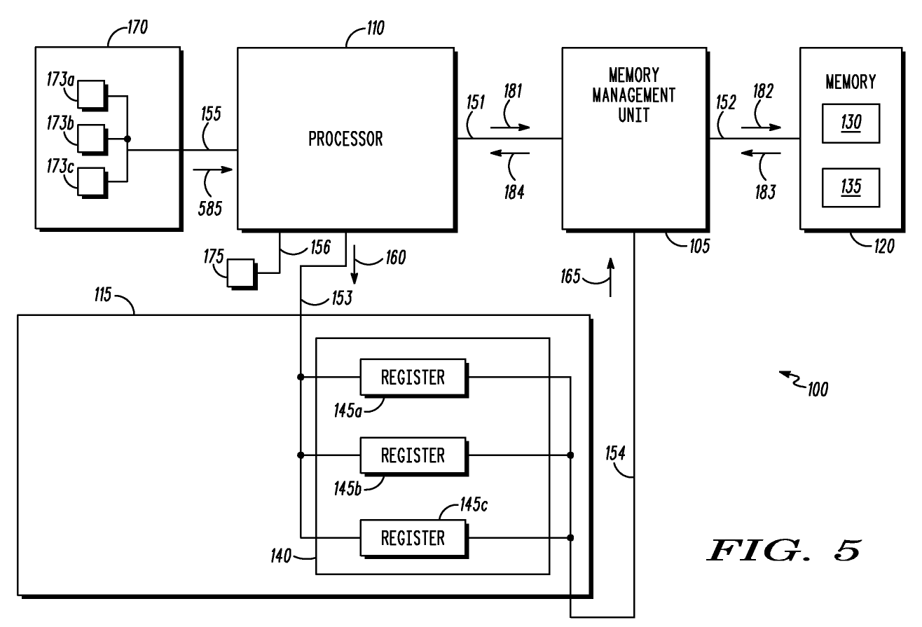

FIG. 5 is a drawing of still another logic device 100 having a memory management unit 105 with protection configuration as described in various representative embodiments. In the representative embodiment of FIG. 5, reprogramming of the configuration of the memory management unit 105 by an attacker is prevented by providing a lock protection mode option for each first register 145, which are lockable, multiple-write registers, during programming following the initiation of start-up. The lock protection mode can be applied once to each lockable, multiple-write first register 145 after final programming of the multiple-write registers. The lockable, multiple-write first registers 145 associated with the memory management unit 105 are reprogrammable until the lock protection is given to it following processor 110 reset, i.e., until start-up is reinitiated. Each lockable, multiple-write first register 145 can be programmed to specify an area of memory to be non-executable and lockable. In this case, the area of memory cannot be used to execute any instructions and the lockable, multiple-write first register 145 used by the memory management unit 105 can not be reprogrammed once it has been locked.

The logic device 100 of FIG. 5 comprises the processor 110, the memory management unit 105, the memory-management-unit register module 115, and a memory module 120. The memory module 120 comprises a data memory section 130 and an executable memory section 135. The logic device 100 comprises an enabled indicator 175. The register module 115 comprises at least one lockable, multiple-write first register 145 which may be implemented in hardware and/or software. Multiple lockable, multiple-write first registers 145a,145b,145c are shown as first registers 145 in FIG. 5. For each of the first registers 145a,145b,145c, an indicator unit 170 comprises a protection indicator 173, which may also be referred to herein as a second indicator 173. FIG. 5 shows three protection indicators 173a,173b,173c, one for each of the three lockable, multiple-write first registers 145a,145b,145c.

The processor 110 communicates with the memory management unit 105 via the first communication bus 151; the memory management unit 105 communicates with the memory module 120 and thereby with both the data memory section 130 and the executable memory section 135 via the second communication bus 152; the processor 110 communicates with the lockable, multiple-write first registers 145 via the third communication bus 153; the memory management unit 105 communicates with the lockable, multiple-write first registers 145 in the register module 115 via the fourth communication bus 154; the processor 110 communicates with the indicator unit 170 and thereby the protection indicators 173 via the fifth communication bus 155; and the processor 110 communicates with the enabled indicator 175 via the sixth communication bus 156.

The lockable, multiple-write first registers 145 are programmed by the processor 110 via the first register configuration data 160 transmitted to the lockable, multiple-write first registers 145 on the third communication bus 153. Following start-up or reset of the processor 110, each lockable, multiple-write first register 145 can be programmed any number of times until its corresponding protection indicator 173 is set to indicate that that lockable, multiple-write first registers 145 is locked. Following such lock, that lockable, multiple-write first register 145 can not be programmed further and its associated data memory section 130 in the memory module 120 is specified to be non-executable or is specified to be executable. First control data 165 can be subsequently obtained from the programmed contents of the lockable, multiple-write first registers 145 on the fourth communication bus 154. Once locked, any attempt to reprogram any of the lockable, multiple-write first registers 145 will send an alert to the processor 110. The enabled indicator 175 which is used to enable the memory management unit 105 should be writable only once (until processor 110 reset) in order to prevent an attacker from disabling the memory management unit 105 thereby disabling the write protection of the lockable, multiple-write first registers 145.

During operation, the processor 110 transmits first communication signal 181 to the memory management unit 105 via first communication bus 151; the memory management unit 105 transmits second communication signal 182 to the memory module 120 via second communication bus 152; third communication signal 183 is received from the memory module 120 by the memory management unit 105 via second communication bus 152; fourth communication signal 184 is received from the memory module 120 by the processor 110 via first communication bus 151; and lock protect mode data 185 is received from the protection indicators 173 via fifth communication bus 155. The first communication signal 181 may comprise data to be written into the data memory section 130 of the memory module 120, executable code to be written into the executable memory section 135 of the memory module 120, and/or instructions to the memory management unit 105; the second communication signal 182 may comprise data which was received from the processor 110 that is to be written into the data memory section 130 of the memory module 120 or executable code to be written into the executable memory section 135 of the memory module 120; the third communication signal 183 may comprise data which was read from the data memory section 130 of the memory module 120 or executable code which was read from the executable memory section 135 of the memory module 120; the fourth communication signal 184 may comprise data which was read from the data memory section 130 of the memory module 120, executable code which was read from the executable memory section 135 of the memory module 120, or responses to instructions received by the memory management unit 105 from the processor 110; and the lock protect mode data 185 may comprise data from the protection indicators 173 which indicate whether or not each of the lockable, multiple-write first registers 145 are locked.

If an area of translated memory is programmed in one of the lockable, multiple-write first registers 145 that is locked and in another lockable, multiple-write first registers 145 that is not locked, an alert will be sent to the processor 110. In which case, an attacker is excluded from by-passing the locked lockable, multiple-write first registers 145 by reprogramming the non-locked lockable, multiple-write first registers 145. Once a lockable, multiple-write first registers 145 is protected from being reprogrammed by the lock protection mode, the memory management unit 105 will not be permitted to be disabled. This prevents an attacker from disabling the memory management unit 105 entirely, which would then disable the protections.

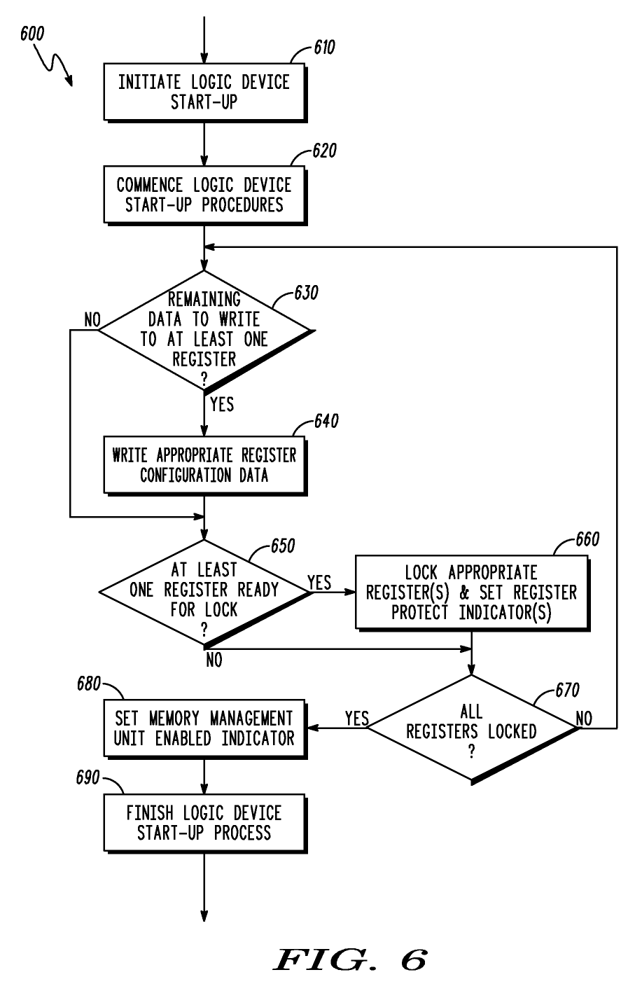

FIG. 6 is a flow chart of another method 600 for protecting the configuration of the memory management unit 105 of a logic device 100 as described in various representative embodiments. In block 610, logic device 100 start-up is initiated. Block 610 then transfers control to block 620.

In block 620, the logic device 100 start-up procedures are automatically commenced following the initiation of start-up. The use of the plural term “start-up procedures” is meant herein to include one or more procedures. Block 620 then transfers control to block 630.

If there is data to write to at least one lockable, multiple-write first register 145, block 630 transfers control to block 640. Otherwise block 630 transfers control to block 650.

In block 640, first register configuration data 160 is written into the lockable, multiple-write first registers 145. Block 640 then transfers control to block 650.

If there is at least one lockable, multiple-write first register 145 ready to be locked, block 650 transfers control to block 660. Otherwise block 650 transfers control to block 670.

In block 660, appropriate lockable, multiple-write first register 145 that are ready to be locked are locked and the protection indicator 173 associated with each first register 145 just locked is set. Block 660 then transfers control to block 670.

If all lockable, multiple-write first registers 145 which are intended to be locked are locked, block 670 transfers control to block 680. Otherwise block 670 transfers control back to block 630.

In block 680, the enabled indicator 175 is set such that an attacker is prevented from disabling the memory management unit 105 thereby disabling the write protection of the lockable, multiple-write first registers 145. Block 680 then transfers control to block 690.

In block 690, the logic device 100 start-up procedures are completed. The start-up process is finished in block 690.

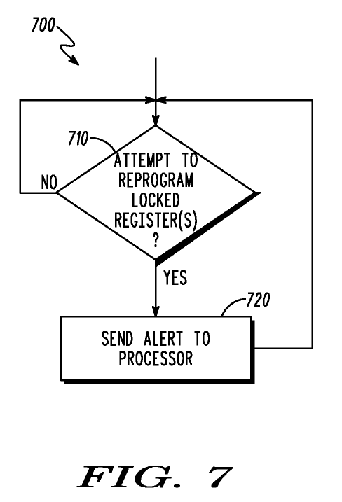

FIG. 7 is a flow chart of a method 700 for notifying a logic device 100 processor 110 of a potential attack on a protected memory area of the memory module 120 of FIG. 5. If an attempt was made to reprogram one or more of the lockable, multiple-write first registers 145, block 710 transfers control to block 720. Otherwise, block 710 transfers control back to block 710 to repeat its conditional check.

In block 720, the logic device 100 processor 110 is notified of an attack on the protected memory area of the memory module 120 via the configuration data in the lockable, multiple-write first registers 145. Block 720 then terminates the process.

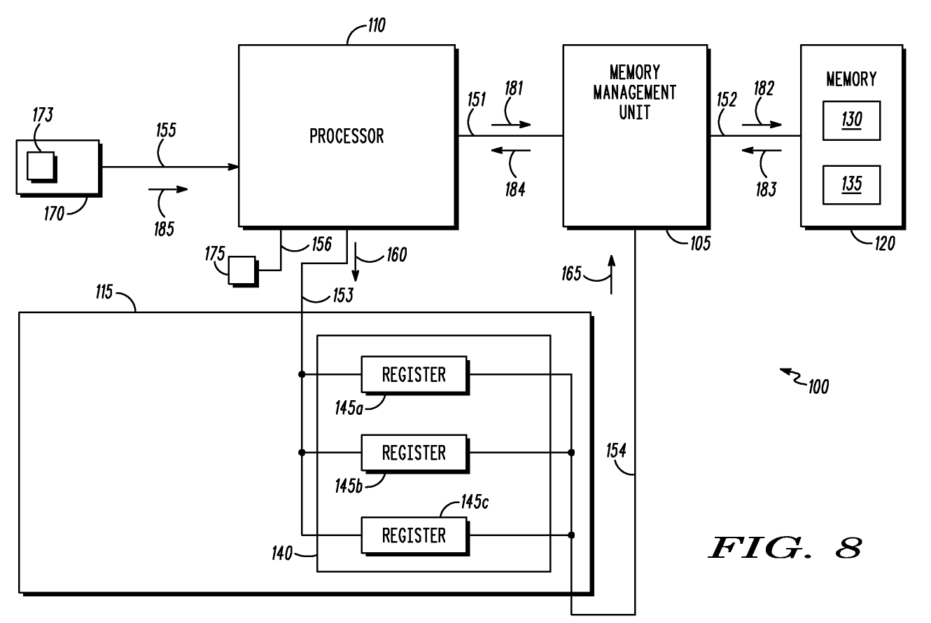

FIG. 8 is a drawing of yet another logic device 100 having a memory management unit 105 with protection configuration as described in various representative embodiments. In the representative embodiment of FIG. 8, reprogramming of the configuration of the memory management unit 105 by an attacker is prevented by providing a lock protection mode option for all of the first registers 145, which are lockable, multiple-write registers, during programming following start-up or reset. The lock protection mode can be applied once for all of the lockable, multiple-write first registers 145. The lockable, multiple-write first registers 145 associated with the memory management unit 105 are reprogrammable until the lock protection is put in place following processor 110 reset. Each lockable, multiple-write first register 145 can be programmed to specify an area of memory to be non-executable and lockable. In this case, the area of memory cannot be used to execute any instructions and the lockable, multiple-write first register 145 used by the memory management unit 105 can not be reprogrammed.

Following start-up or reset of the processor 110, each lockable, multiple-write first registers 145 can be programmed any number of times until the protection indicator 173 is set to indicate that all of the lockable, multiple-write first registers 145 are locked. Following such lock, the lockable, multiple-write first registers 145 can not be programmed further and the associated data memory section 130 in the memory module 120 is specified to be non-executable and lockable. First control data 165 can be subsequently obtained from the programmed contents of the lockable, multiple-write first registers 145 on the fourth communication bus 154. Once locked, any attempt to reprogram any of the lockable, multiple-write first registers 145 will send an alert to the processor 110. The enabled indicator 175 which is used to enable the memory management unit 105 should be writable only once in order to prevent an attacker from disabling the memory management unit 105 thereby disabling the write protection of the lockable, multiple-write first registers 145.

In an alternative embodiment, the protection indicator 173 or equivalently the enabled indicator 175, either of which could be implemented as a bit in a register, can perform both functions of blocking reprogramming of the lockable, multiple-write first registers 145 and of blocking reprogramming of overriding the memory management unit 105.

In another representative embodiment of FIG. 8, a second register unit 240 comprising at least one second register 245 as shown in FIG. 2 is added. A single protection indicator 173 can be used to prevent the lockable, multiple-write first registers 145 from being reprogrammed while allowing the second registers 245 to remain unlocked and thus to be reprogrammable. For this embodiment, a check should be in place to prevent the same translated memory from being programmed in both a locked register 145 and an unlocked register 245 similar to that discussed in connection with FIG. 2. If such an attempt is made, an alert will be sent to the processor 110 thereby preventing an attacker from by-passing the locked lockable, multiple-write first registers 145 by reprogramming the unlocked second registers 245.

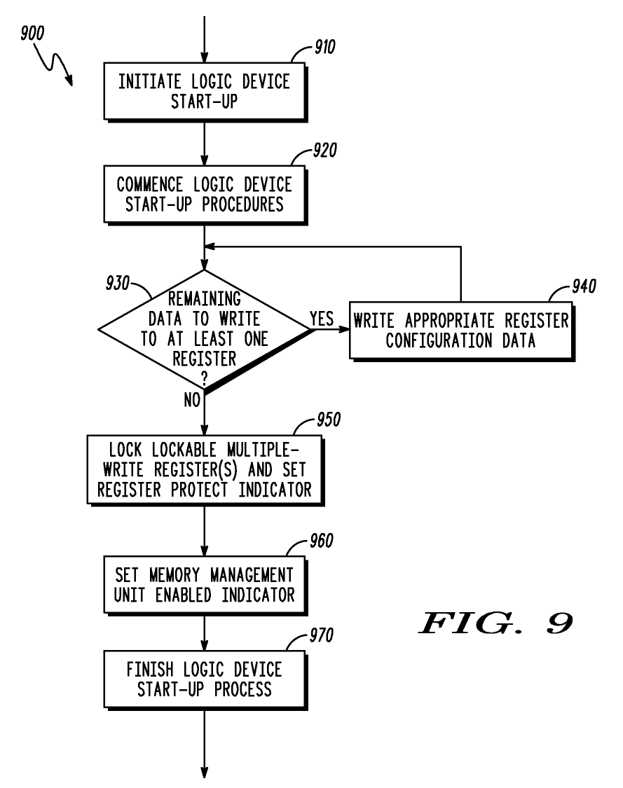

FIG. 9 is a flow chart of yet another method 900 for protecting the configuration of the memory management unit 105 of a logic device 100 as described in various representative embodiments. In block 910, logic device 100 start-up is initiated. Block 910 then transfers control to block 920.

In block 920, the logic device 100 start-up procedures are automatically commenced following the initiation of start-up. The use of the plural term “start-up procedures” is meant herein to include one or more procedures. Block 920 then transfers control to block 930.

If there is data to write to at least one lockable, multiple-write first register 145, block 930 transfers control to block 940. Otherwise block 930 transfers control to block 950.

In block 940, first register configuration data 160 is written into the lockable, multiple-write first registers 145. Block 940 then transfers control back to block 930.

In block 950, the lockable, multiple-write first register 145 are locked and the protection indicator 173 is set. Block 950 then transfers control to block 960.

In block 960, the enabled indicator 175 is set such that an attacker is prevented from disabling the memory management unit 105 thereby disabling the write protection of the lockable, multiple-write first registers 145. Note that blocks 950 and 960 can be optionally combined by either setting the protection indicator 173 or the enabled indicator 175 to indicate that both the lockable, multiple-write first registers 145 and the memory management unit 105 are protected (i.e., locked). Block 960 then transfers control to block 970.

In block 970, the logic device 100 start-up procedures are completed. The start-up process is finished in block 970.

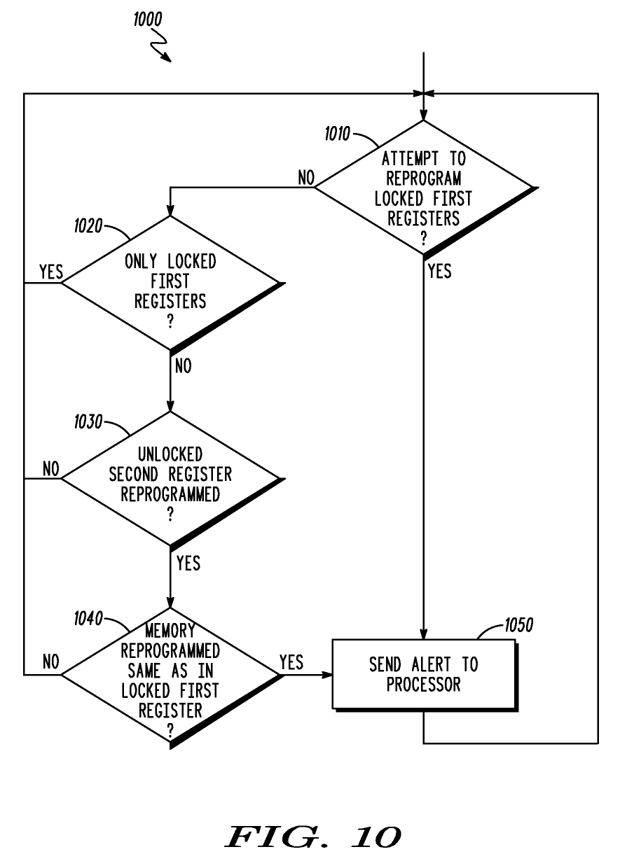

FIG. 10 is a flow chart of yet still another method 1000 for notifying a logic device 100 processor 110 of an attack on a protected memory area of the memory module 120 of FIG. 8. If an attempt is made to reprogram one or more of the lockable, multiple-write first registers 145, block 1010 transfers control to block 1050. Otherwise, block 1010 transfers control to block 1020.

If the registers of the memory-management-unit register module 115 comprises only lockable, multiple-write first registers 145, block 1020 transfers control back to block 1010. Otherwise, block 1020 transfers control to block 1030.

If one or more of the second registers 245 were reprogrammed, block 1030 transfers control to block 1040. Otherwise, block 1030 transfers control back to block 1010.

If the area of translated memory programmed in one or more of the second registers 245 is the same as the translated memory programmed in one or more of the locked lockable, multiple-write first registers 145, block 1040 transfers control to block 1050. Otherwise block 1040 transfers control back to block 1010.

In block 1050, the logic device 100 processor 110 is notified of an attack on the locked memory area of the memory module 120 via the configuration data in the unlocked second registers 245 and/or the locked lockable, multiple-write first registers 145. Block 1050 then transfers control back to block 1010.

The dynamic allocation of virtual memory needed by some operating systems can present problems with locking the registers that control the configuration of the memory management unit 105. For example, when an operating system is running two processes at once, it may place both processes in separate areas of translated memory, but at different times place the processes in the same area of virtual memory. When the operating system does a context switch, it will swap the contents of the registers that control the configuration of the memory management unit 105 for the current process mapping with contents that control the configuration of the memory management unit 105 for the other process. To affect this swap, one or more registers need to be kept unlocked.

An attacker can exploit an unlocked register by programming it with a mapping from virtual memory to a translated memory that is being protected by a locked register. Then the attacker can modify this virtual memory to change the protected translated memory. To prevent this type of attack on the configuration of the memory management units 105 as described above, a comparison of the translated address in the unlocked registers associated with virtual memory with the translated addresses in the locked registers associated with translated memory is done when an unlocked register is programmed.

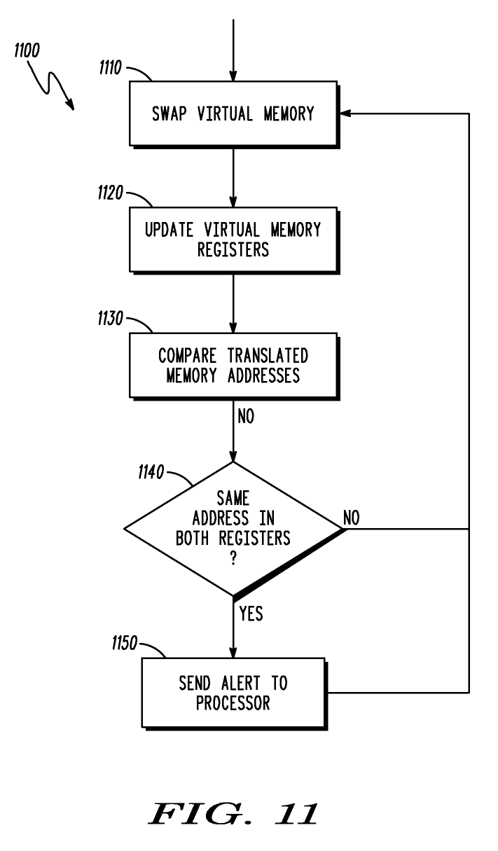

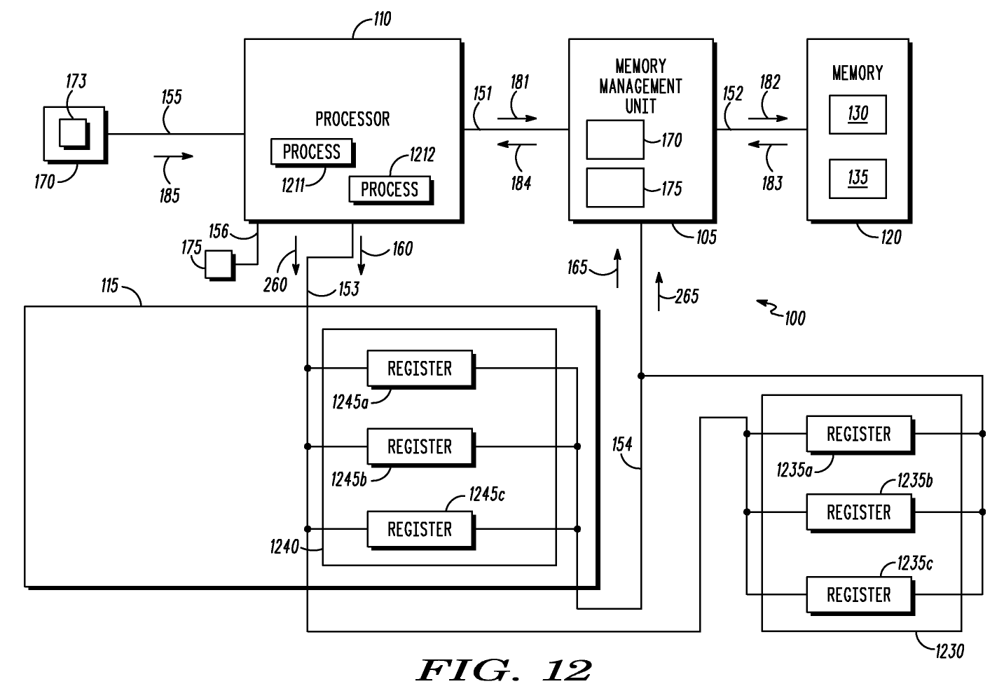

FIG. 11 is a flow chart of a method 1100 for notifying a logic device processor 110 of a potential attack on a protected memory area 130 of the memory module 120 as described in various representative embodiments. In block 1110 of FIG. 11, an area of virtual memory is swapped with another area of virtual memory which could be, for example, associated with the processor 110 of the logic device 100 swapping a first process 1211 (see FIG. 12) for a second process 1212 (see FIG. 12). Block 1110 then transfers control to block 1120.

In block 1120, the contents of the registers associated with the virtual memory, which could be for example the virtual memory registers 1245 (see FIG. 12), are updated to reflect the swap in virtual memory. Block 1120 then transfers control to block 1130.

In block 1130, the contents of the virtual memory registers 1245 associated with the virtual memory are compared with the contents of the other virtual memory registers 1245. Block 1130 then transfers control to block 1140.

If the same translated address is found in another virtual memory register 1245, block 1140 transfers control to block 1150. Otherwise, block 1140 transfers control back to block 1110.

In block 1150, the logic device 100 processor 110 is notified of an attack on the locked memory area of the memory module 120 via the configuration data in the unprotected virtual memory registers 1245. Block 1150 then transfers control back to block 1110. In a small memory management unit 105 architecture with only a few registers, this comparison is relatively simple and quick. However, for logic devices 100 with a large number of registers, this comparison can become resource intensive.

FIG. 12 is a drawing of still yet another logic device 100 having a memory management unit 105 with protection configuration as described in various representative embodiments. In an alternative to the translated memory comparison of the memory management unit 105 registers just described, a set of translated memory registers 1235 in a translated memory register unit 1230 can be used to protect translated memory. The attributes of the virtual memory addresses in the virtual memory registers 1245 are checked against the protections on translated memory as found in the translated memory registers 1235. An alert to the processor 110 will be issued if a protection violation is found. As previously indicated, the swapping of virtual memory can be associated with swapping the second process 1212 for the first process 1211.

The translated memory registers 1235 could be protected from being reprogrammed by the methods described above with appropriated setting of the indicator unit 170 comprising one or more protection indicators 173 used to indicate that the translated memory registers 1235 are so protected. The protection indicators 173 should be writable only once to prevent the reprogramming of the translated memory registers 1235. The enabled indicator 175 which is used as above to enable the memory management unit 105 should also to be writable only once in order to prevent an attacker from disabling the memory management unit 105 thereby disabling the write protection of the registers 145. In addition, due to timing issues, it may be necessary to include a set of bits to indicate whether or not the data in the translated memory registers 1235 and the virtual memory registers 1245 are valid.

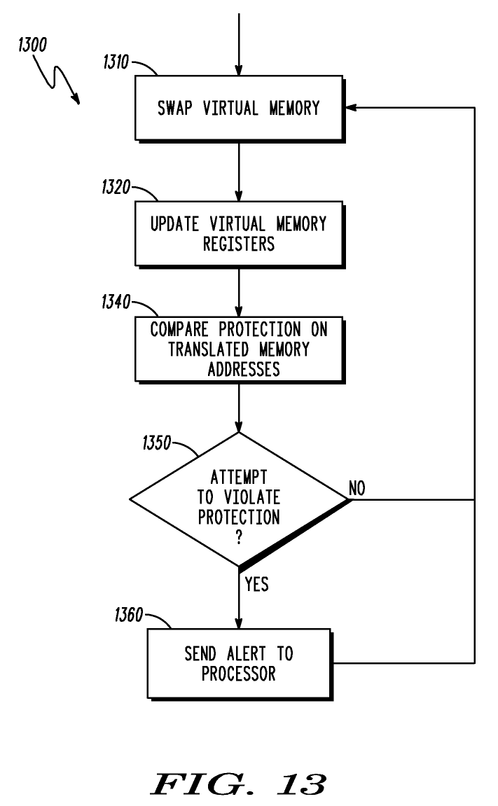

FIG. 13 is a flow chart of another method 1300 for notifying a logic device processor 110 of a potential attack on a locked memory area 130 of the memory modules 120 as described in various representative embodiments. In block 1310 of FIG. 13, an area of virtual memory is swapped with another area of virtual memory which could be, for example, associated with the processor 110 of the logic device 100 swapping a first process 1211 for a second process 1212. Block 1310 then transfers control to block 1320.

In block 1320, the contents of the registers associated with the virtual memory which could be, for example, the virtual memory registers 1245 of FIG. 12 are updated to reflect the swap in virtual memory. Block 1320 then transfers control to block 1340.

In block 1340, the attributes of the protected translated addresses stored in the translated memory registers 1235 are compared with the attributes of the addresses stored in the virtual memory registers 1245 for the virtual memory addresses. Block 1340 then transfers control to block 1350.

If a violation of the protection is found to have been attempted in the comparison of block 1340, block 1350 transfers control to block 1360. Otherwise, block 1350 transfers control back to block 1310.

In block 1360, the logic device 100 processor 110 is notified of an attack on the protected memory area of the memory module 120 via the configuration data associated with the swapped virtual memory stored in the virtual memory registers 1245. Block 1360 then transfers control back to block 1310.

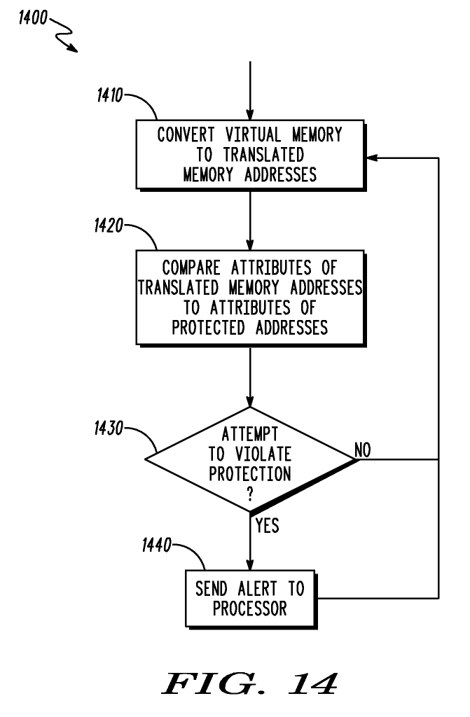

FIG. 14 is a flow chart of another method 1400 for notifying a processor 110 of a potential attack on a locked memory area 130 of the memory modules 120 as described in various representative embodiments. In block 1410 of FIG. 14, the virtual memory addresses are converted to translated memory addresses using the virtual memory registers 1245. Block 1410 then transfers control to block 1420.

In block 1420, the translated memory address is compared to the attributes of the protected translated addresses stored in the translated memory registers 1235. Block 1420 then transfers control to block 1430.

If a violation of the protection is found to have been attempted in the comparison of block 1420, block 1430 transfers control to block 1440. Otherwise, block 1430 transfers control back to block 1410.

In block 1440, the processor 110 is notified of an attack on the protected memory area of the memory module 120 via the configuration data associated with the translated memory stored in the translated memory registers 1235. Block 1440 then transfers control back to block 1410.

Equivalent embodiments, other than those shown in the drawings and/or discussed herein, are also possible that are consistent with these disclosures. In particular, dependent upon the implementation, the processor 110 can be any of various types of control modules 110. Among other devices, the control module 110 could be a flash memory unit which implements control from the instructions previously programmed into it. Also, the processor 110 or control module 110 can interact with multiple memory management units 105 rather than only one as discussed above.

Some memory management units in use today require that they be disabled in order to change one of the unit's registers. The memory management unit is first disabled, the register is changed, and then the memory management unit is re-enabled. Some representative embodiments disclosed herein comprise two sets of registers with one set being locked and the other being non-locked. If a memory management unit requires that it be disabled during operation in order to change the non-locked registers, it is possible for an attacker to change the locked registers during the same time. This situation can be prevented by providing two memory management unit enable bits. One bit is for only the locked registers, and the other bit is for only the non-locked registers. In this case, once the enable bit for the locked registers is set, the locked registers cannot be changed. However, the memory management unit enable bit for the non-locked registers can be changed whenever the non-locked registers need to be changed.

As will be understood by one of ordinary skill in the art, attributes for memory addresses other than executable and non-executable can also be protected using embodiments disclosed herein. In particular, memory addresses having the attributes of read only, write only, read and write, and the like can also be protected.

As is the case, in many data-processing products, the systems described above may be implemented as a combination of hardware and software components. Moreover, the functionality required for use of the representative embodiments may be embodied in computer-readable media (such as floppy disks, conventional hard disks, DVDs, CD-ROMs, Flash ROMs, nonvolatile ROM, and RAM) to be used in programming an information-processing apparatus (e.g., the logic device 100 comprising the elements shown in FIG. 1 among others) to perform in accordance with the techniques so described.

The term “program storage medium” is broadly defined herein to include any kind of logic device memory such as, but not limited to, floppy disks, conventional hard disks, DVDs, CD-ROMs, Flash ROMs, nonvolatile ROM, and RAM.

In representative embodiments, techniques have been disclosed above for preventing an attacker from executing code previously represented to a logic device as data and subsequently stored in the system's memory by the attacker. Techniques disclosed herein prevent the reprogramming of the system's memory management unit 105 so that it cannot be used by clandestine sources to change previously specified memory address ranges from being data memory to being executable memory. An attacker can thereby be prevented from executing code that had been previously represented to the system as data and stored in the data area of the system's memory but which was, in fact, executable code.

The representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

What is claimed is:

1. A logic device comprising:
a control module;
a memory management unit;
a memory module, wherein the memory management unit controls flow of software code between the control module and the memory module;
a register module comprising a first register unit, wherein the first register unit comprises at least one first register, wherein the control module programs at least one of the first registers during start-up procedures of the logic device to specify at least one data memory section in the memory module, wherein the memory management unit communicates with the first registers to identify the at least one data memory section, and wherein the memory management unit excludes executable code from storage in the at least one data memory section;
an indicator unit comprising a second indicator, wherein, prior to completion of the start-up procedures, the second indicator is set by the control module to indicate that the first registers are write protected, thereby preventing subsequent programming of the first registers;
a first indicator, wherein, prior to completion of the start-up procedures, the first indicator is set by the control module to indicate that the memory management unit is enabled and cannot be disabled without shutting down the logic device.

2. The logic device as recited in claim 1, wherein each of the multiple first registers can be programmed only once.

3. The logic device as recited in claim 2, wherein the register module further comprises a second register unit, wherein the second register unit comprises at least one second register, and wherein each second register can be rewritten as appropriate without limit.

4. The logic device as recited in claim 3, wherein if the same memory address is stored in one first register and in one of the second registers, the memory management unit notifies the control module of that condition.

5. The logic device as recited in claim 1, wherein, for each first register, the indicator unit further comprises a separate, associated second indicator, wherein each first register can be programmed multiple times prior to being write protected, and wherein, after each first register has been programmed for the last time prior to completion of the start-up procedures, its associated second indicator is set by the control module to indicate that that first register is locked, thereby preventing subsequent programming of that first register.

6. The logic device as recited in claim 5, wherein if the same memory address is stored in one first register, the memory management unit notifies the control module of that condition.

7. The logic device as recited in claim 1, wherein, for each first register, the indicator unit further comprises a separate, associated second indicator, wherein each first register can be programmed multiple times prior to being write protected, and wherein, after each first register has been programmed for the last time prior to completion of the start-up procedures, its associated second indicator is set by the control module to indicate that that first register is locked, thereby preventing subsequent programming of that first register.

8. The logic device as recited in claim 7, wherein the register module further comprises a second register unit, wherein the second register unit comprises at least one second register, and wherein the control module is capable of programming as appropriate each second register multiple times both prior to and after completion of the start-up procedures.

9. The logic device as recited in claim 8, wherein if the same memory address is stored in one first register and in one of the second registers, the memory management unit notifies the control module of that condition.

10. A logic device comprising:
a control module;
a memory management unit;
a memory module, wherein the memory management unit controls flow of software code between the control module and the memory module;
a translated memory register unit comprising at least one translated memory register, wherein at least one of the translated memory registers is programmed to specify at least one data memory section in the memory module, wherein the data memory section is specified to contain only non-executable software code, and wherein the translated memory registers are protected; and
a virtual memory register unit comprising at least one virtual memory register, wherein the control module programs at least one of the virtual memory registers to specify at least one data memory section in the memory module, wherein the memory management unit communicates with the virtual memory registers to identify the at least one data memory section, and wherein the memory management unit compares memory storage limitations specified in translated memory registers with memory storage limitations specified in the virtual memory registers and excludes executable code from storage in any virtual memory register specified data memory section that is not also one of the translated memory register specified data memory sections.

11. The logic device as recited in claim 10, further comprising:
a first indicator, wherein, prior to completion of start-up procedures, the first indicator is set by the control module to indicate that the memory management unit is enabled and cannot be disabled without shutting down the logic device.

12. The logic device as recited in claim 10, further comprising:
an indicator unit comprising a second indicator, wherein, prior to completion of start-up procedures, the second indicator is set by the control module to indicate that the translated memory registers are write protected, thereby preventing subsequent programming of the translated memory registers.

13. The logic device as recited in claim 10, wherein if any virtual memory register specified data memory section is not also one of the translated memory register specified data memory sections, the memory management unit notifies the control module of that condition.

14. A method, comprising:
initiating start-up of a logic device;
commencing start-up procedures for the logic device;
writing first register configuration data into at least one translated first register, wherein the configuration data specifies certain sections of a memory module as being data memory sections which are permitted to contain only non-executable software code;
protecting the first registers from further programming;
setting an enabled indicator to indicate that a memory management unit is active;
completing the start-up procedures for the logic device; and
using the memory management unit to restrict the flow of software code from a control module to the memory module based on the configuration data written into first registers.

15. The method as recited in claim 14, wherein the first registers are write-once registers.

16. The method as recited in claim 14, wherein the first registers are lockable, multiple-write registers.

17. The method as recited in claim 14, further comprising:
if an attempt is made to reprogram one or more of the first memory registers following protecting the first registers, providing notification of a potential attack on the protected memory area of the memory module via modification of the configuration data in the first registers.

18. A method, comprising:
initiating start-up of a logic device;
commencing start-up procedures for the logic device;
writing appropriate configuration data into at least one translated memory register, wherein the configuration data specifies certain sections of a memory module as being data memory sections which are permitted to contain only non-executable software code;
protecting the translated memory registers from further programming;
completing the start-up procedures for the logic device;
swapping an area of virtual memory with another area of virtual memory;
updating contents of at least one virtual memory register associated with the virtual memory to reflect the swap in virtual memory;
comparing the attributes of the addresses stored in the translated memory registers with the attributes of the addresses stored in the virtual memory registers; and
if a violation of the protection is found to have been attempted, using a memory management unit to restrict the flow of software code from a control module to the memory module based on result of comparing the attributes.

19. The method as recited in claim 18, further comprising:
if a violation of the protection is found to have been attempted, notifying the control module of a potential attack on the protected memory area of the memory module via the configuration data associated with the swapped virtual memory stored in the virtual memory registers.

20. A method, comprising:
initiating start-up of a logic device;
commencing start-up procedures for the logic device;
writing appropriate configuration data into at least one translated memory register, wherein the configuration data specifies certain sections of a memory module as being data memory sections which are permitted to contain only non-executable software code;
protecting the translated memory registers from further programming;
completing the start-up procedures for the logic device;
converting a virtual memory address to a translated memory address using a virtual memory register;
comparing the translated address with the attributes of the addresses stored in the translated memory registers; and
if a violation of the protection is found to have been attempted, using a memory management unit to restrict the flow of software code from a control module to the memory module based on result of comparing the attributes.

21. The method as recited in claim 20, further comprising:
if a violation of the protection is found to have been attempted, notifying the control module of a potential attack on the protected memory area of the memory module via the configuration data associated with the translated memory registers.
